(19) United States
(12) Patent Application Publication
(10) Pub. No.: US 2016/0295241 A1
(43) Pub. Date: Oct. 6, 2016

(54) VIDEO ENCODING APPARATUS AND METHOD, VIDEO DECODING APPARATUS AND METHOD, AND PROGRAMS THEREFOR

(71) Applicant: NIPPON TELEGRAPH AND TELEPHONE CORPORATION, Chiyoda-ku, Tokyo (JP)

(72) Inventors: Shinya SHIMIZU, Yokosuka-shi (JP); Shiori SUGIMOTO, Yokosuka-shi (JP); Akira KOJIMA, Yokosuka-shi (JP)

(73) Assignee: NIPPON TELEGRAPH AND TELEPHONE CORPORATION, Tokyo (JP)

(21) Appl. No.: 15/038,611

(22) PCT Filed: Dec. 3, 2014
(86) PCT No.: PCT/JP2014/081986

§ 371 Date: May 23, 2016

(30) Foreign Application Priority Data
Dec. 3, 2013 (JP) 2013-250429

(51) Int. Cl. H04N 19/597; H04N 13/00; H04N 19/51

(52) U.S. Cl. CPC H04N 19/597; H04N 19/51; H04N 13/0048

(57) ABSTRACT

Based on a representative depth determined from a depth map corresponding to an object in a multi-viewpoint video, a transformation matrix is determined which transforms a position on an encoding target image, which is one frame of the multi-viewpoint video, into a position on a reference viewpoint image from a reference viewpoint which differs from the viewpoint of the encoding target image. A representative position is determined which belongs to an encoding target region obtained by dividing the encoding target image. A corresponding position which corresponds to the representative position and belongs to the reference viewpoint image is determined by using the representative position and the transformation matrix. Based on the corresponding position, synthesized motion information assigned to the encoding target region is generated from motion information for the reference viewpoint image, and a predicted image for the encoding target region is generated by using the synthesized motion information.

### TECHNICAL FIELD

The present invention relates to a video encoding apparatus, a video decoding apparatus, a video encoding method, a video decoding method, a video encoding program, and a video decoding program.

### BACKGROUND ART

A free viewpoint video is a video for which a user can freely select the position or direction of a camera (which is called a “viewpoint” hereafter) in the photographing space. Although the user designate any viewpoint for the free viewpoint video, it is impossible to maintain videos corresponding to all possible viewpoints. Therefore, the free viewpoint video is formed by information items required to produce a video from a designated viewpoint.

The free viewpoint video may also be called a free viewpoint television, an arbitrary viewpoint video, or an arbitrary viewpoint television.

The free viewpoint video is represented by using one of various data formats. The most common format utilizes a video and a depth map (i.e., a distance image) for each frame of the video (see, for example, Non-Patent Document 1).

In the depth map, depth (i.e., distance) from the relevant camera to each object is described for each pixel, which represents a three-dimensional position of the object. When a certain condition is satisfied, the depth is proportional to the reciprocal of disparity between the cameras. Therefore, the depth map may be called a “disparity map (or disparity image)”.

In the field of computer graphics, the depth is information stored in a Z buffer, and the relevant map is called a Z image or a Z map.

Instead of the distance from the camera to the object, the coordinate values for the Z axis of a three-dimensional coordinate system defined in a space for a representation target. Generally, since the horizontal and vertical directions for a photographic image are defined as the X axis and the Z axis, the Z axis coincides with the direction of the camera. However, the Z axis may not coincide with the direction of the camera, for example, when a common coordinate system is applied to a plurality of cameras.

In the following explanations, the distance and the Z value are each called the depth without distinguishing therebetween, and an image which employs the depth as each pixel value is called a “depth map”. However, strictly speaking, a pair of cameras as a reference should be defined for a disparity map.

In order to represent the depth as a pixel value, three methods are known: a method to directly determine a value corresponding to a physical quantity to a pixel value; a method that utilizes a value obtained by quantizing a range between a minimum value and a maximum value to a certain number; and a method that utilizes a value obtained by quantizing a difference from a minimum value with a certain step width. When a range for desired representation is limited, the depth can be represented highly accurately by using additional information such as the minimum value.

Additionally, when the quantization is performed at equal intervals, there are two methods, that is, a target physical quantity may be directly quantized or the reciprocal of the physical quantity may be quantized. The reciprocal of distance is proportional to the disparity. Therefore, when highly accurate representation of the distance is required, the former method is employed in most cases. Contrarily, when highly accurate representation of the disparity is required, the latter method is employed in most cases.

Below, regardless of the pixel value obtaining method or the quantization method for the depth, any representation of the depth as an image is called the depth map

Since one value is assigned to each pixel in the depth map representation, the depth map can be regarded as a gray scale image. Furthermore, since each object continuously exists in a real space and cannot move instantaneously to a position apart from the current position, the depth map has spatial and temporal correlation similar to an image signal. Therefore, an image or video encoding method utilized to encode an ordinary image or video signal can efficiently encode a depth map or a video formed by continuous depth maps by removing spatial and temporal redundancy.

Below, a depth map and a video formed by depth maps are each called the depth map without distinguishing therebetween.

Here, general video encoding will be explained. In the video encoding, in order to implement efficient encoding by utilizing spatial and temporal continuity of each object, each frame of a video is divided into processing unit blocks called “macroblocks”. A video signal of each macroblock is spatial or temporal predicted, and prediction information, that indicates the utilized prediction method, and a prediction residual are encoded.

In the spatial prediction of a video signal, the prediction information may be information which indicates a direction of the spatial prediction. In the temporal prediction, the prediction information may be information which indicates a frame to be referred to and information which indicates the target position in the relevant frame.

Since the spatial prediction is a prediction executed in a frame, it is called an intra-frame prediction (or intra prediction). Since the temporal prediction is a prediction performed between frames, it is called an inter-frame prediction (or inter prediction).

Additionally, in the temporal prediction, a temporal variation of an image, that is, a motion is compensated so as to predict a video signal. Therefore, the temporal prediction may be called a “motion-compensated prediction”.

In addition, in order to encode a multi-viewpoint video consisting of videos which are obtained by photographing a single scene from a plurality of positions or in a plurality of directions, prediction of a video signal is performed by compensating a variation between viewpoints of the videos, that is, disparity. Therefore, disparity-compensated prediction is utilized.

In the encoding of a free viewpoint video which is formed by videos from a plurality of viewpoints and corresponding depth maps, the former and latter each have spatial and temporal correlation. Therefore, when each of them is encoded by using an ordinary video encoding method, the relevant amount of data can be reduced.

For example, when a free viewpoint video from a plurality of viewpoints and corresponding depth maps are represented by using MPEG-C Part.3, they each are encoded by using a conventional video encoding method.

When a free viewpoint video from a plurality of viewpoints and corresponding depth maps are encoded together, efficient encoding is implemented by utilizing a correlation between viewpoints with respect to motion information.

In the method of Non-Patent Document 2, for a processing target region, a region in a previously-processed video from another viewpoint is determined by using a disparity vector, and motion information used when the determined region was encoded is utilized as motion information for the processing target region or a predicted value thereof. In order to implement efficient encoding in this process, a highly accurate disparity vector should be obtained for the processing target region.

As the simplest method, Non-Patent Document 2 determines a disparity vector, which is assigned to a region temporally or spatially adjacent to the processing target region, to be the disparity vector for the processing target region. In order to obtain a more accurate disparity vector, in a known method, a depth of the processing target region is estimated or acquired, and the depth is converted to obtain the disparity vector.

### PRIOR ART DOCUMENT

### Non-Patent Document

Non-Patent Document 1: Y. Mori, N. Fukusima, T. Fujii, and M. Tanimoto, “View Generation with 3D Warping Using Depth Information for FTV”, In Proceedings of 3DTV-CON2008, pp. 229-232, May 2008.
Non-Patent Document 2: G. Tech, K. Wegner, Y. Chen and S. Yea, “3D-HEVC Draft Text I”, JCT-3V Doc., JCT3V-E1001 (version 3), September, 2013.

### DISCLOSURE OF INVENTION

### Problem to be Solved by the Invention

According to the method disclosed in Non-Patent Document 2, a value of the depth map is converted to obtain a highly accurate disparity vector, which makes it possible to implement highly efficient predictive encoding.

However, when the depth is converted to a disparity vector in the method of Non-Patent Document 2, it is assumed that the disparity is proportional to the reciprocal of the depth (i.e., distance from the camera to the object). More specifically, the disparity is computed by computing a product between three elements: the reciprocal of the depth, the focal length of the camera, and the distance between the relevant viewpoints. Such a conversion produces an accurate result when the relevant two viewpoints have the same focal length and the directions of the viewpoints (i.e., optical axes of the cameras) are three-dimensionally parallel to each other three-dimensional. However, in the other situations, an erroneous result is produced.

As disclosed in Non-Patent Document 1, in order to execute accurate conversion, it is necessary to (i) obtain a three-dimensional point by reversely projecting a point on an image to a three-dimensional space in accordance with the depth and then (ii) re-project the three-dimensional point onto another viewpoint so as to compute a point corresponding to said other viewpoint on the image.

However, such a conversion requires complex computation, which increases the amount of computation. Additionally, for two viewpoints having different directions, there is very little probability that the motion vectors for the viewpoints coincide with each other on the video. Therefore, even when an accurate disparity vector could be obtained, if motion information for another viewpoint is used as motion information for the processing target region according to the method of Non-Patent Document 2, erroneous motion information is provided and efficient encoding cannot be implemented.

In light of the above circumstances, an object of the present invention is to provide a video encoding apparatus, a video decoding apparatus, a video encoding method, a video decoding method, a video encoding program, and a video decoding program, by which in the encoding of a free viewpoint video data formed by videos from a plurality of viewpoints and corresponding depth maps, even if the directions of the viewpoints are not parallel to each other, efficient video encoding can be implemented by improving the accuracy of inter-viewpoint prediction for the motion vector.

### Means for Solving the Problem

The present invention provides a video encoding apparatus utilized when an encoding target image, which is one frame of a multi-viewpoint video consisting of videos from a plurality of different viewpoints, is encoded, wherein the encoding is executed while performing prediction between different viewpoints for each of encoding target regions divided from the encoding target image, and the apparatus comprises:

a representative depth determination device that determines a representative depth from a depth map corresponding to an object in the multi-viewpoint video:

a transformation matrix determination device that determines based on the representative depth, a transformation matrix that transforms a position on the encoding target image into a position on a reference viewpoint image from a reference viewpoint which differs from a viewpoint of the encoding target image;

a representative position determination device that determines a representative position which belongs to the relevant encoding target region;

a corresponding position determination device that determines a corresponding position which corresponds to the representative position and belongs to the reference viewpoint image by using the representative position and the transformation matrix;

a motion information generation device that generates, based on the corresponding position, synthesized motion information assigned to the encoding target region, according to reference viewpoint motion information as motion information for the reference viewpoint image; and

a predicted image generation device that generates a predicted image for the encoding target region by using the synthesized motion information.

In a typical example, the video encoding apparatus further comprises:

a depth region determination device that determines a depth region on the depth map, where the depth region corresponds to the encoding target region.

wherein the representative depth determination device determines the representative depth from a depth map that corresponds to the depth region.

In this case, the video encoding apparatus may further comprise:

a depth reference disparity vector determination device that determines, for the encoding target region, a depth reference disparity vector that is a disparity vector for the depth map.

wherein the depth region determination device determines a region indicated by the depth reference disparity vector to be the depth region.

Furthermore, the depth reference disparity vector determination device may determine the depth reference disparity vector by using a disparity vector used when a region adjacent to the encoding target region was encoded.

In addition, from among depths in the depth region which correspond to pixels at four vertexes of the encoding target region having a rectangular shape, the representative depth determination device may select and determine a depth, which indicates that it is closest to a target camera, to be the representative depth.

In a preferable example, the video encoding apparatus further comprises:

a synthesized motion information transformation device that performs transformation of the synthesized motion information by using the transformation matrix,

wherein the predicted image generation device uses the transformed synthesized motion information.

In another preferable example, the video encoding apparatus further comprises:

a past depth determination device that determines, based on the corresponding position and the synthesized motion information, a past depth from the depth map:

an inverse transformation matrix determination device that determines based on the past depth, an inverse transformation matrix that transforms the position on the reference viewpoint image into the position on the encoding target image; and

a synthesized motion information transformation device that performs transformation of the synthesized motion information by using the inverse transformation matrix,

wherein the predicted image generation device uses the transformed synthesized motion information.

The present invention also provides a video decoding apparatus utilized when a decoding target image is decoded from encoded data of a multi-viewpoint video consisting of videos from a plurality of different viewpoints, wherein the decoding is executed while performing prediction between different viewpoints for each of decoding target regions divided from the decoding target image, and the apparatus comprises:

a representative depth determination device that determines a representative depth from a depth map corresponding to an object in the multi-viewpoint video;

a transformation matrix determination device that determines based on the representative depth, a transformation matrix that transforms a position on the decoding target image into a position on a reference viewpoint image from a reference viewpoint which differs from a viewpoint of the decoding target image;

a representative position determination device that determines a representative position which belongs to the relevant decoding target region:

a corresponding position determination device that determines a corresponding position which corresponds to the representative position and belongs to the reference viewpoint image by using the representative position and the transformation matrix;

a motion information generation device that generates, based on the corresponding position, synthesized motion information assigned to the decoding target region, according to reference viewpoint motion information as motion information for the reference viewpoint image; and

a predicted image generation device that generates a predicted image for the decoding target region by using the synthesized motion information.

In a typical example, the video decoding apparatus further comprises:

a depth region determination device that determines a depth region on the depth map, where the depth region corresponds to the decoding target region,

wherein the representative depth determination device determines the representative depth from a depth map that corresponds to the depth region.

In this case, the video decoding apparatus may further comprise:

a depth reference disparity vector determination device that determines, for the decoding target region, a depth reference disparity vector that is a disparity vector for the depth map,

wherein the depth region determination device determines a region indicated by the depth reference disparity vector to be the depth region.

Furthermore, the depth reference disparity vector determination device may determine the depth reference disparity vector by using a disparity vector used when a region adjacent to the decoding target region was encoded.

In addition, from among depths in the depth region which correspond to pixels at four vertexes of the decoding target region having a rectangular shape, the representative depth determination device may select and determine a depth, which indicates that it is closest to a target camera, to be the representative depth.

In a preferable example, the video decoding apparatus further comprises:

a synthesized motion information transformation device that performs transformation of the synthesized motion information by using the transformation matrix,

wherein the predicted image generation device uses the transformed synthesized motion information.

In another preferable example, the video decoding apparatus further comprises:

a past depth determination device that determines, based on the corresponding position and the synthesized motion information, a past depth from the depth map;

an inverse transformation matrix determination device that determines based on the past depth, an inverse transformation matrix that transforms the position on the reference viewpoint image into the position on the decoding target image; and

a synthesized motion information transformation device that performs transformation of the synthesized motion information by using the inverse transformation matrix,

wherein the predicted image generation device uses the transformed synthesized motion information.

The present invention also provides a video encoding method utilized when an encoding target image, which is one frame of a multi-viewpoint video consisting of videos from a plurality of different viewpoints, is encoded, wherein the encoding is executed while performing prediction between different viewpoints for each of encoding target regions divided from the encoding target image, and the method comprises:

a representative depth determination step that determines a representative depth from a depth map corresponding to an object in the multi-viewpoint video:

a transformation matrix determination step that determines based on the representative depth, a transformation matrix that transforms a position on the encoding target image into a position on a reference viewpoint image from a reference viewpoint which differs from a viewpoint of the encoding target image;

a representative position determination step that determines a representative position which belongs to the relevant encoding target region;

a corresponding position determination step that determines a corresponding position which corresponds to the representative position and belongs to the reference viewpoint image by using the representative position and the transformation matrix;

a motion information generation step that generates, based on the corresponding position, synthesized motion information assigned to the encoding target region, according to reference viewpoint motion information as motion information for the reference viewpoint image; and

a predicted image generation step that generates a predicted image for the encoding target region by using the synthesized motion information.

The present invention also provides a video decoding method utilized when a decoding target image is decoded from encoded data of a multi-viewpoint video consisting of videos from a plurality of different viewpoints, wherein the decoding is executed while performing prediction between different viewpoints for each of decoding target regions divided from the decoding target image, and the method comprises:

a representative depth determination step that determines a representative depth from a depth map corresponding to an object in the multi-viewpoint video;

a transformation matrix determination step that determines based on the representative depth, a transformation matrix that transforms a position on the decoding target image into a position on a reference viewpoint image from a reference viewpoint which differs from a viewpoint of the decoding target image:

a representative position determination step that determines a representative position which belongs to the relevant decoding target region;

a corresponding position determination step that determines a corresponding position which corresponds to the representative position and belongs to the reference viewpoint image by using the representative position and the transformation matrix;

a motion information generation step that generates, based on the corresponding position, synthesized motion information assigned to the decoding target region, according to reference viewpoint motion information as motion information for the reference viewpoint image; and

a predicted image generation step that generates a predicted image for the decoding target region by using the synthesized motion information.

The present invention also provides a video encoding program that makes a computer execute the video encoding method.

The present invention also provides a video decoding program that makes a computer execute the video decoding method.

### Effect of the Invention

In accordance with the present invention, when a video from a plurality of viewpoints is encoded or decoded together with depth maps for the video, a corresponding relationship between pixels from different viewpoints is obtained by using one matrix defined for relevant depth values. Accordingly, even if the directions of the viewpoints are not parallel to each other, the accuracy of the motion vector prediction between the viewpoints can be improved without performing complex computation, by which the video can be encoded with a reduced amount of code.

### BRIEF DESCRIPTION OF THE DRAWINGS

FIG. 1 is a block diagram that shows the structure of a video encoding apparatus according to an embodiment of the present invention.

FIG. 2 is a flowchart that shows the operation of the video encoding apparatus 100 of FIG. 1.

FIG. 3 is a flowchart that shows the operation (step S104) of generating motion information performed by the motion information generation unit 105 in FIG. 2 (see step S104).

FIG. 4 is a block diagram that shows the structure of a video decoding apparatus according to an embodiment of the present invention.

FIG. 5 is a flowchart that shows the operation of the video encoding apparatus 200 of FIG. 4.

FIG. 6 is a block diagram that shows an example of a hardware configuration of the video encoding apparatus 100 (shown in FIG. 1) formed using a computer and a software program.

FIG. 7 is a block diagram that shows an example of a hardware configuration of the video decoding apparatus 200 (shown in FIG. 4) formed using a computer and a software program.

### MODE FOR CARRYING OUT THE INVENTION

Below, a video encoding apparatus and a video decoding apparatus in accordance with an embodiment of the present invention will be explained with reference to the drawings.

In the following explanations, it is assumed that a multi-viewpoint video obtained by a first camera (called “camera A”) and a second camera (called “camera B”) is encoded, where one frame of the video obtained by the camera B is encoded or decoded by utilizing the camera A as a reference viewpoint.

It is also assumed that information required to obtain disparity from the depth is separately given. Such information may be an external parameter which indicates a positional relationship between the cameras A and B or an internal parameter which indicates information about projection onto an image plane by a camera. However, necessary information may be provided in a different manner if the provided information has a meaning identical to that of the above parameters.

Such camera parameters are explained in detail, for example, in the following document: “Three-Dimension Computer Vision”, MIT Press: BCTC/UFF-006.37 F259 1993, ISBN:0-262-06158-9”. This document includes explanations about a parameter which indicates a positional relationship between a plurality of cameras and a parameter which indicates information about the projection onto an image plane by a camera.

In the following explanations, it is also assumed that an image signal sampled by using pixel(s) at a position or in a region, or a depth for the image signal, is indicated by adding information by which the relevant position can be identified (i.e., coordinate values or an index that can be associated with the coordinate values, for example, an encoding target region index “blk” explained later) to an image, a video frame, or a depth map.

It is further assumed that addition of an index, which can be assigned to coordinate values or a block, and a vector indicates that coordinate values or a block at a position determined by shifting the original coordinate values or block by a vector.

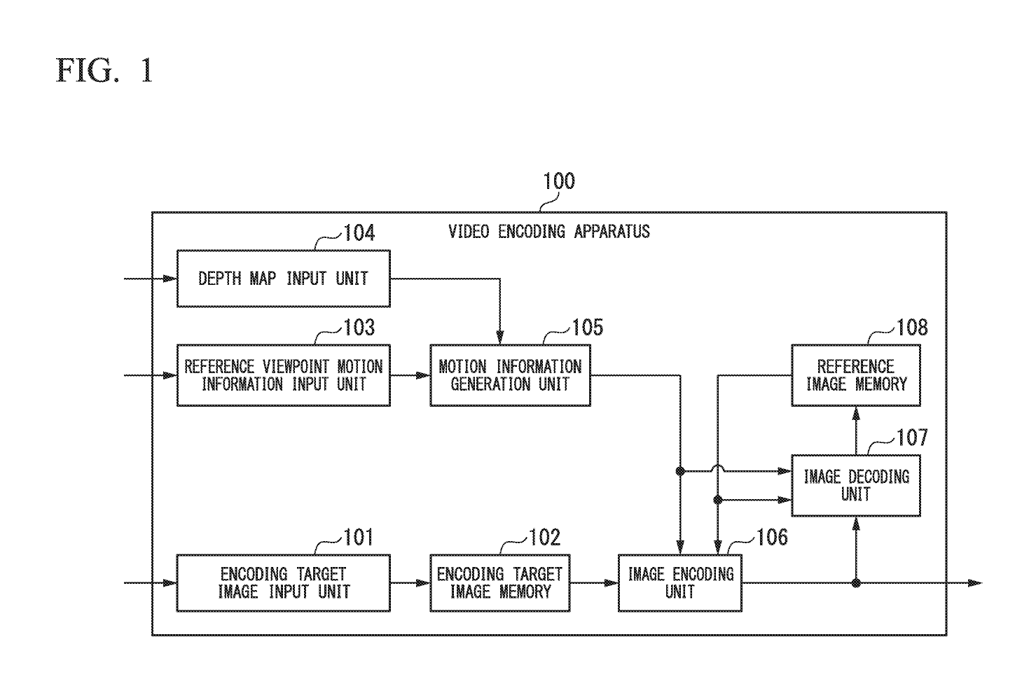

FIG. 1 is a block diagram that shows the structure of the video encoding apparatus according to the present embodiment.

As shown in FIG. 1, the video encoding apparatus 100 has an encoding target image input unit 101, an encoding target image memory 102, a reference viewpoint motion information input unit 103, a depth map input unit 104, a motion information generation unit 105, an image encoding unit 106, an image decoding unit 107, and a reference image memory 108.

The encoding target image input unit 101 inputs one frame of a video as an encoding target into the video encoding apparatus 100. Below, this video as an encoding target and the frame that is input and encoded are respectively called an “encoding target video” and an “encoding target image”. Here, a video obtained by the camera B is input frame by frame. In addition, the viewpoint (here, the viewpoint of camera B) from which the encoding target image is photographed is called an “encoding target viewpoint”.

The encoding target image memory 102 stores the input encoding target image.

The reference viewpoint motion information input unit 103 inputs motion information (e.g., a motion vector) for a video from a reference viewpoint into the video encoding apparatus 100. Below, this input motion information is called “reference viewpoint motion information”. Here, the motion information for the camera A is input.

The depth map input unit 104 inputs a depth map, which is referred to when a correspondence relationship between pixels from different viewpoints is obtained or motion information is generated, into the video encoding apparatus 100. Although a depth map for the encoding target image is input here, a depth map from another viewpoint (e.g., reference viewpoint) may be input.

Here, the depth map represents a three-dimensional position of an object at each pixel of the relevant image in which the object is imaged. For example, the distance from the camera to the object, the coordinate values for an axis which is not parallel to the image plane, or the amount of disparity with respect to another camera (e.g., camera A) may be employed.

Although the depth map here is provided as an image, it may be provided in any manner if similar information can be obtained.

The motion information generation unit 105 generates motion information for the encoding target image by using the reference viewpoint motion information and the depth map.

The image encoding unit 106 predictive-encodes the encoding target image by using the generated motion information.

The image decoding unit 107 decodes a bit stream of the encoding target image.

The reference image memory 108 stores an image obtained when the decoding the bit stream of the encoding target image.

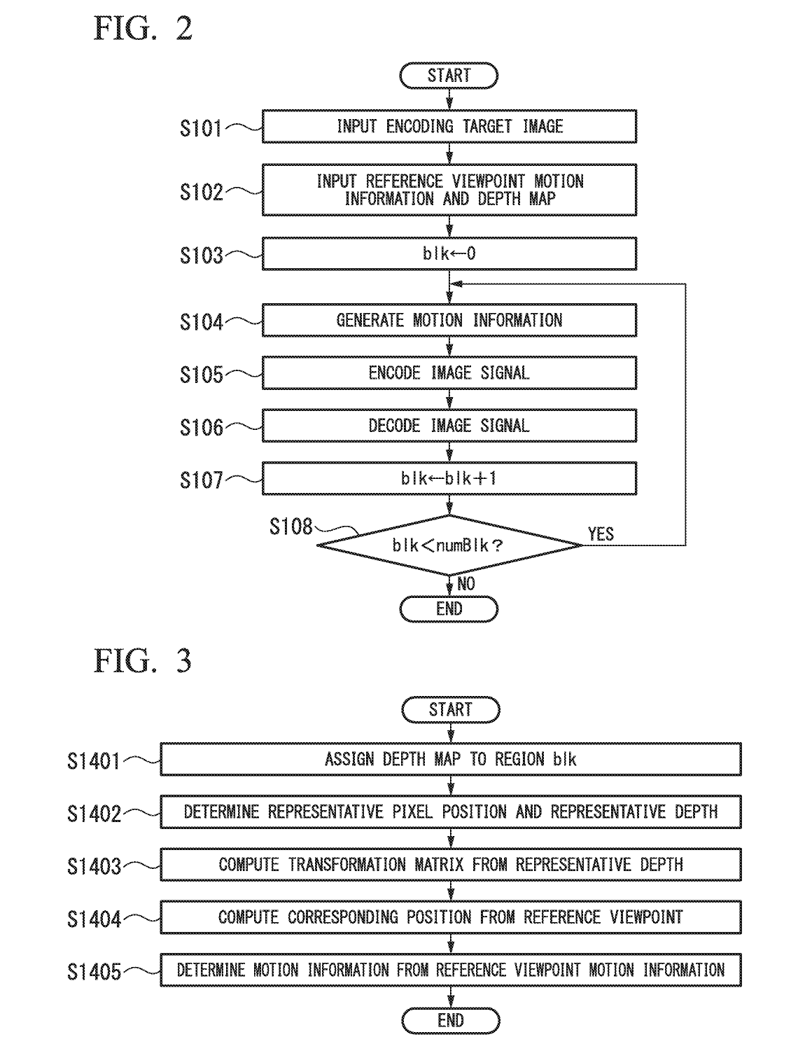

Next, with reference to FIG. 2, the operation of the video encoding apparatus 100 of FIG. 1 will be explained. FIG. 2 is a flowchart that shows the operation of the video encoding apparatus 100 of FIG. 1.

First, the encoding target video input unit 101 makes an encoding target image Org input into the apparatus and stores the image in the encoding target image memory 102 (see step S101).

Next, the reference viewpoint motion information input unit 103 makes the reference viewpoint motion information into the video encoding apparatus 100 while the depth map input unit 104 makes the depth map into the video encoding apparatus 100. These input items are each output to the motion information generation unit 105 (see step S102).

Here, it is assumed that the reference viewpoint motion information and the depth map input in step S102 are identical to those used in a corresponding decoding apparatus, for example, those which were previously encoded and are decoded. This is because generation of encoding noise (e.g., drift) can be suppressed by using the completely same information as information which can be obtained in the decoding apparatus. However, if generation of such encoding noise is acceptable, information which can be obtained only in the encoding apparatus may be input (e.g., information which has not yet been encoded).

As for the depth map, instead of a depth map which has already been encoded and is decoded, a depth map estimated by applying stereo matching or the like to a multi-viewpoint video which is decoded for a plurality of cameras, or a depth map estimated by using a decoded disparity or motion vector may be utilized as identical information which can be obtained in the decoding apparatus.

The reference viewpoint motion information may be motion information used when a video from the reference viewpoint was encoded or motion information which has been encoded separately for the reference viewpoint. In addition, motion information obtained by decoding a video from the reference viewpoint and performing estimation according to the decoded video may be utilized.

After the input of the encoding target image, the reference viewpoint motion information, and the depth map is completed, the encoding target image is divided into regions having a predetermined size, and the video signal of the encoding target image is encoded for each divided region (see steps S103 to S108).

More specifically, given “blk” for an encoding target region index and “numBlks” for the total number of encoding target regions, blk is initialized to be 0 (see step S103), and then the following process (from step S104 to step S106) is repeated adding 1 to blk each time (see step S107) until blk reaches numBlks (see step S108).

In ordinary encoding, the encoding target image is divided into processing target blocks called “macroblocks” each being formed as 16×16 pixels. However, it may be divided into blocks having another block size if the condition is the same as that in the decoding apparatus. In addition, instead of dividing the entire image into regions having the same size, the divided regions may have individual sizes.

In the process repeated for each encoding target region, first, the motion information generation unit 105 generates motion information for the encoding target region blk (see step S104). This process will be explained in detail later.

After the motion information for the encoding target region blk is obtained, the image encoding unit 106 encodes the video signal (specifically, pixel values) of the encoding target image in the encoding target region blk while performing the motion-compensated prediction by using the motion information and an image stored in the reference image memory 108 (see step S105). A bit stream obtained by the encoding functions as an output signal from the video encoding apparatus 100. Here, the encoding may be performed by any method.

In generally known encoding such as MPEG-2 or H.264/AVC, a differential signal between the image signal and the predicted image of block blk is sequentially subjected to frequency transformation such as DCT, quantization, binarization, and entropy encoding.

Next, the image decoding unit 107 decodes the video signal of the block blk from the bit stream and stores a decoded image Dec[blk] as a decoding result in the reference image memory 108 (see step S106).

Here, a method corresponding to the method utilized in the encoding is used. For example, for generally known encoding such as MPEG-2 or H.264/AVC, the encoded data is sequentially subjected to entropy decoding, inverse binarization, inverse quantization, and frequency inverse transformation such as IDCT. The obtained two-dimensional signal is added to the predicted signal, and the added result is finally subjected to clipping within a range of the pixel values, thereby decoding the image signal.

Here, the decoding process may be performed in a simplified decoding manner by receiving the relevant data and predicted image immediately before the process in the encoding apparatus becomes lossless.

That is, in the above-described example, the video signal may be decoded by receiving a value after performing the quantization in the encoding and the relevant motion-compensated image: sequentially applying the inverse quantization and the frequency inverse transformation to the quantized value so as to obtain the two-dimensional signal; adding the motion-compensated predicted image to the two-dimensional signal; and performing the clipping within the range of the pixel values.

Next, with reference to FIG. 3, the process (in step S104) of generating the motion information in the encoding target region blk, performed by the motion information generation unit 105, will be explained in detail. FIG. 3 is a flowchart that shows the operation of the motion information generation unit 105 in FIG. 2 (see step S104).

In the process of generating the motion information, first, the motion information generation unit 105 assigns a depth map to the encoding target region blk (see step S1401). Since a depth map for the encoding target image has been input, a depth map at the same location as that of the encoding target region blk is assigned.

When the encoding target image and the depth map have different resolutions, a region scaled according to the ratio between the resolutions is assigned. With given “depth viewpoint” that differs from the encoding target viewpoint, if a depth map for the depth viewpoint is used, a disparity DV between the encoding target viewvpoint and the depth viewpoint in the encoding target region blk is computed and a depth map at blk+DV is assigned to the encoding target region blk. As described above, when the encoding target image and the depth map have different resolutions, scaling for the position and size is executed according to the ratio between the resolutions.

The disparity DV between the encoding target viewpoint and the depth viewpoint may be computed by any method if this method is also employed in the decoding apparatus.

For example, a disparity vector used when a peripheral region adjacent to the encoding target region blk was encoded, a global disparity vector assigned to the entire encoding target image or a partial image that includes the encoding target region, or a disparity vector which is assigned to the encoding target region separately and encoded may be utilized. In addition, a disparity vector which was assigned to a different region or a previously-encoded image may be stored in advance and utilized.

Furthermore, a disparity vector obtained by transforming a depth map at the same location as the encoding target region in depth maps which were previously encoded for the encoding target viewpoint may be utilized.

Next, from the assigned depth map, the motion information generation unit 105 determines a representative pixel position “pos” (as the representative position in the present invention) and a representative depth “rep” (see step S1402). Although the representative pixel position and the representative depth may be determined by any method, the method should also be employed by the decoding apparatus.

A representative method of determining the representative pixel position “pos” is a method of determining a predetermined position (e.g., the center or upper-left in the encoding target region) as the representative pixel position, or a method of determining the representative depth and then determining the position of a pixel (in the encoding target region) which has the same depth as the representative depth.

In another method, depths of pixels at predetermined positions are compared with each other and the position of a pixel having a depth which satisfies a predetermined condition is assigned.

Specifically, in four pixels at the center of the encoding target region, pixels at four vertexes (of a rectangular encoding target region), or pixels at the four vertexes and the center position, a pixel that provides the maximum depth, the minimum depth, or a depth as the median is selected.

A representative method of determining the representative depth “rep” is a method of utilizing an average, a median, the maximum value, the minimum value, or the like of the depth map for the encoding target region.

In addition, the average, median, maximum value, minimum value, or the like of depth values of, not all pixels in the encoding target region, but part of the pixels may be utilized. As the part of the pixels, those at the four vertexes or at the four vertexes and the center position may be employed. Furthermore, the depth value at a predetermined position (e.g., the center or upper-left) in the encoding target region may be utilized.

After the representative pixel position “pos” and the representative depth are obtained, the motion information generation unit 105 computes a transformation matrix Hᵣₑₚ (see step S1403).

The transformation matrix is called a “homography matrix”. On the assumption that an object is present on a plane represented by a representative depth, a correspondence relationship between the points on the image plane from different viewpoints is given by the transformation matrix. The transformation matrix Hᵣₑₚ may be computed by any method, for example, by the following formula:

$${H}_{rep} = R + \frac{t {n ( {D}_{rep} )}^{T}}{d ( {D}_{rep} )} \qquad [ Formula 1 ]$$

Here, R and t respectively denote a 3×3 rotation matrix and a translation vector between the encoding target viewpoint and the reference viewpoint. Dᵣₑₚ denotes the representative depth and n(Dᵣₑₚ) denotes a normal vector (corresponding to the representative depth Dᵣₑₚ) of a three-dimensional plane for the encoding target viewpoint. Additionally, d(Dᵣₑₚ) denotes a distance between the three-dimensional plane and the center of the encoding target viewpoint and the reference viewpoint. In addition, “T” at the upper-right position represents a transposition of the relevant vector.

In another method of computing transformation matrix Hᵣₑₚ, for different four points pᵢ (i=1, 2, 3, 4) on the encoding target image, corresponding points qᵢ for the reference viewpoint are computed by the following formula:

$${P}_{r} ( {P}_{t}^{- 1} \begin{matrix}( \begin{matrix}{d}_{t} ( {p}_{i} ) ( \begin{matrix}{p}_{i} \\ 1\end{matrix} ) \\ 1\end{matrix} ) \\ 1\end{matrix} ) = s ( \begin{matrix}{q}_{i} \\ 1\end{matrix} ) \qquad [ Formula 2 ]$$

Here, pᵢ and qᵢ respectively indicate 3×4 camera matrices for the encoding target viewpoint and the reference viewpoint. With given internal parameter “A” for the relevant camera, rotation matrix “R” from a world coordinate system (any common coordinate system independent of the camera) to the camera coordinate system, and row vector “t” that indicates a translation from the world coordinate system to the camera coordinate system, each camera matrix is given by A[R|t], where [R|t] indicates a 3×4 matrix formed by arraying R and t and is called an external parameter of the camera. An inverse matrix P⁻¹ of the relevant camera matrix P is a matrix corresponding to inverse transformation of the transformation by using the camera matrix P and is represented as R⁻¹ [A⁻¹|−t].

When it is assumed that the depth at point pi on the encoding target image is the representative depth, “dₜ(pᵢ)” denotes a distance along the optical axis from the encoding target viewpoint to the object at the point pi.

In addition, “s” is any real number. If the camera parameters have no error, “s” equals to a distance “dᵣ(qᵢ)” along the optical axis from the reference viewpoint at point qᵢ on the image from the reference viewpoint to the object at the point qᵢ.

When Formula 2 is computed according to the above definitions, the following formula is obtained, where subscripts “t” and “r” appended to the internal parameter A, the rotation matrix R, and the translation vector t represent individual cameras and respectively indicate the encoding target viewpoint and the reference viewpoint:

$${A}_{r} ( {R}_{r} {R}_{t}^{- 1} ( {A}_{t}^{- 1} {d}_{t} ( {p}_{i} ) ( \begin{matrix}{p}_{i} \\ 1\end{matrix} ) - {t}_{i} ) + {t}_{r} ) = s ( \begin{matrix}{q}_{i} \\ 1\end{matrix} ) \qquad [ Formula 3 ]$$

After the four corresponding points are computed, the transformation matrix Hᵣₑₚ is obtained by solving a homogeneous equation acquired by the following formula, where any real number (e.g., 1) is applied to component (3,3) of the transformation matrix Hᵣₑₚ:

$$[ \begin{matrix}{\tilde{p}}_{i}^{T} & {0}^{T} & - {q}_{i , 1} {\tilde{p}}_{i}^{T} \\ {0}^{T} & {\tilde{p}}_{i}^{T} & - {q}_{i , 2} {\tilde{p}}_{i}^{T}\end{matrix} ] [ \begin{matrix}{h}_{1} \\ {h}_{2} \\ {h}_{3 }\end{matrix} ] = 0 \\ {\tilde{p}}_{i} = ( \begin{matrix}{p}_{i} \\ 1\end{matrix} ) , \\ {q}_{i} = ( \begin{matrix}{q}_{i , 1} \\ {q}_{i , 2}\end{matrix} ) , \\ {H}_{rep} = [ \begin{matrix}{h}_{1}^{T} \\ {h}_{2}^{T} \\ {h}_{3}^{T}\end{matrix} ] \qquad [ Formula 4 ]$$

Since the transformation matrix Hp depends on the reference viewpoint and the depth. Hᵣₑₚ may be computed every time the representative depth is computed. In another example, before the process applied to each region is started, a transformation matrix is computed for each combination of the reference viewpoint and the depth, and when Hᵣₑₚ is determined, one transformation matrix is selected from the previously-computed transformation matrices based on the reference viewpoint and the representative depth.

After the transformation matrix for the representative depth is computed, the motion information generation unit 105 computes a corresponding position from the reference viewpoint according to the following formula (see step S1404):

$$k ( \begin{matrix}u \\ v \\ 1\end{matrix} ) = {H}_{rep} ( \begin{matrix}pos \\ 1\end{matrix} ) \qquad [ Formula 5 ]$$

where “k” denotes an arbitrary real number, and the position defined by (u, v) is the target position from the reference viewpoint.

After the position from the reference viewpoint is computed, the motion information generation unit 105 determines stored reference viewpoint motion information, which was assigned to a region that includes the relevant position, to be motion information for the encoding target region blk (see step S1405).

If no reference viewpoint motion information was stored for such a region that includes the relevant position, (i) information without motion information may be determined, (ii) default motion information (e.g., zero vector) may be determined, or (iii) a region which is closest to the corresponding position (u, v) and stores motion information is identified and reference viewpoint motion information stored for this region may be determined. Here, the motion information is determined based on a rule identical to that employed in the decoding apparatus.

In the above explanation, the reference viewpoint motion information is directly determined as the motion information. However, motion information may be determined by setting a predetermined time interval, and scaling motion information in accordance with the predetermined time interval and a time interval for the reference viewpoint motion information so as to replace the time interval for the reference viewpoint motion information with the predetermined time interval.

Accordingly, since motion information items generated for different regions have the same time interval, it is possible to unify the reference image utilized in the motion-compensated prediction and limit a memory space to be accessed. Such limitation of the memory to be accessed makes it possible to improve the cache (memory) hit rate and the processing speed.

In addition, although the reference viewpoint motion information is directly determined as the motion information in the above explanation, information obtained by means of transformation using the transformation matrix H, may be employed.

That is, when the motion information determined in step S1405 is represented by mv=(mvₓ, mv_{y})^{T}, the transformed motion information mv′ is represented by the following formula:

$$s [ \begin{matrix}{p}^{′} \\ 1\end{matrix} ] = {H}_{rep}^{- 1} [ \begin{matrix}u + {mv}_{x} \\ v + {mv}_{y} \\ 1\end{matrix} ] \\ {mv}^{′} = {p}^{′} - pos \qquad [ Formula 6 ]$$

where “s” is an arbitrary real number.

Furthermore, if depth maps from the reference viewpoint, which correspond to the time interval indicated by the motion information determined in step S1405, can be referred to and “prdep” denotes the depth at position (u+mvₓ, v+mv_{y}), then mv′ may be computed by using p′ which is obtained by the following formula:

$$s [ \begin{matrix}{p}_{i}^{′} \\ 1\end{matrix} ] = {H}_{{d}_{r \to t} ( prdep )}^{- 1} [ \begin{matrix}u + {mv}_{x} \\ v + {mv}_{y} \\ 1\end{matrix} ] \qquad [ Formula 7 ]$$

where d_{r→t}(prdep) denotes a function utilized to transform the depth “prdep” represented for the reference viewpoint into a depth represented for the encoding target viewpoint.

If the encoding target viewpoint and the reference viewpoint use a common axis to represent the depth, the above transformation directly returns the deps provided by the relevant argument.

Although an inverse transformation matrix H⁻¹ of a transformation matrix H utilized to transform a position from the encoding target viewpoint to a position from the reference viewpoint is used, an inverse matrix may computed from a transformation matrix, or an inverse transformation matrix may be directly computed.

In the direct computation, first, four different points q′ᵢ(i=1, 2, 3, 4) on an image from the reference viewpoint, corresponding points p′ᵢ on an image from the encoding target viewpoint are computed:

$$s ( \begin{matrix}{p}^{′} \\ 1\end{matrix} ) = {P}_{t} ( {P}_{r}^{- 1} \begin{matrix}( \begin{matrix}{d}_{r , prdep} ( {q}_{i}^{′} ) ( \begin{matrix}{q}_{i}^{′} \\ 1\end{matrix} ) \\ 1\end{matrix} ) \\ 1\end{matrix} ) \qquad [ Formula 8 ]$$

Here, when “prdep” indicates a depth (defined for viewpoint “r”) at the point q′ᵢ on an image from a viewpoint r, d_{r,prdep}(q′ᵢ) indicates a distance from the viewpoint r to an object at the point q′ᵢ along the optical axis.

After the four corresponding points are computed, an inverse transformation matrix H′ is obtained by solving a homogeneous equation acquired by the following formula, where any real number (e.g., 1) is applied to component (3,3) of the inverse transformation matrix H′:

$$[ \begin{matrix}{\tilde{q}}_{i}^{′ T} & {0}^{T} & - {p}_{i , 1}^{′} {\tilde{q}}_{i}^{′ T} \\ {0}^{T} & {\tilde{q}}_{i}^{′ T} & - {p}_{i , 2}^{′} {\tilde{q}}_{i}^{′ T}\end{matrix} ] [ \begin{matrix}{h}_{1}^{′} \\ {h}_{2}^{′} \\ {h}_{3}^{′}\end{matrix} ] = 0 \\ {\tilde{q}}_{i}^{′ } = ( \begin{matrix}{\tilde{q}}_{i}^{′} \\ 1\end{matrix} ) , \\ {\tilde{p}}_{i}^{′ } = ( \begin{matrix}{\tilde{p}}_{i , 1}^{′} \\ {\tilde{p}}_{i , 2}^{′}\end{matrix} ) , \\ {H}_{prdep}^{′} = {H}_{{d}_{r \to t} ( prdep )}^{- 1} = [ \begin{matrix}{h}_{1}^{′ T} \\ {h}_{2}^{′ T} \\ {h}_{3}^{′ T}\end{matrix} ] \qquad [ Formula 9 ]$$

If depth maps D_{t, Ref(blk)} for the encoding target viewpoint, which correspond to the time interval indicated by the motion information determined in step S1405 can be referred to, motion information mv′_{depth} after the relevant transformation may be computed by using the following formula:

$${nrv}_{depth}^{′} = {p}_{depth}^{′} - pos \\ s . t . \\ depth = {arg min}_{pd} ‖ pd - {D}_{t , Ref ( blk )} [ {p}_{pd}^{′} ] ‖ \\ s [ \begin{matrix}{p}_{pd}^{′} \\ 1\end{matrix} ] = {H}_{pd}^{- 1} [ \begin{matrix}u + {mv}_{x} \\ v + {mv}_{y} \\ 1\end{matrix} ] \qquad [ Formula 10 ]$$

where “∥ ∥” indicates a norm, where L1 norm or L2 norm may be employed.

Both the above-explained transformation and scaling may be employed. In this case, the transformation may be executed after the scaling, or the scaling may be executed after the transformation.

When the motion information used in the above explanation is added to a position from the encoding target viewpoint, the motion information indicates a corresponding position along the time direction. If a corresponding position is represented by performing subtraction, it is necessary to reverse the direction of each relevant vector in the motion information for the formulas employed in the above explanation.

Below, a video decoding apparatus according to the present embodiment will be explained.

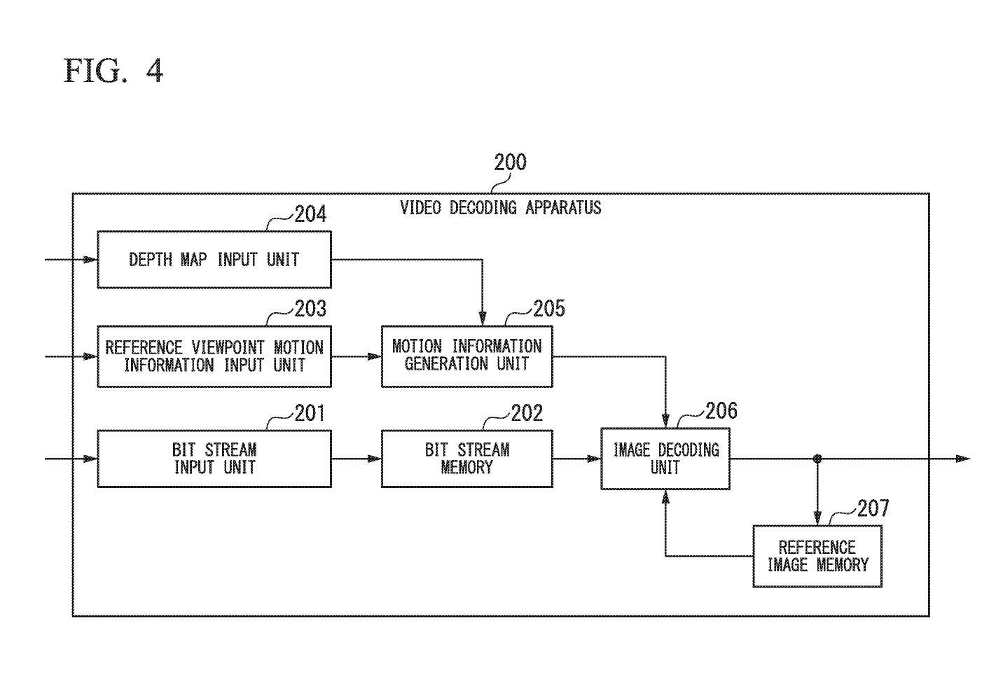

FIG. 4 is a block diagram that shows the structure of the video decoding apparatus according to the present embodiment. The video decoding apparatus 200 has a bit stream input unit 201, a bit stream memory 202, a reference viewpoint motion information input unit 203, a depth map input unit 204, a motion information generation unit 205, an image decoding unit 206, and a reference image memory 207.

The bit stream input unit 201 inputs a bit stream of a video as a decoding target into the video decoding apparatus 200. Below, one frame of the video as the decoding target is called a “decoding target image” (here, one frame of a video obtained by the camera B). In addition, the viewpoint (here, camera B) from which the decoding target video is photographed is called a “decoding target viewpoint”.

The bit stream memory 202 stores the bit stream for the decoding target image.

The reference viewpoint motion information input unit 203 inputs motion information (e.g., a motion vector) for a video from a reference viewpoint into the video decoding apparatus 200. Below, this input motion information is called a “reference viewpoint motion information”. Here, the motion information for the camera A is input.

The depth map input unit 204 inputs a depth map, which is referred to when a correspondence relationship between pixels from different viewpoints is obtained or motion information for the decoding target image is generated, into the video decoding apparatus 200. Although a depth map for the decoding target image is input here, a depth map from another viewpoint (e.g., reference viewpoint) may be input.

Here, the depth map represents a three-dimensional position of an object at each pixel of the relevant image in which the object is imaged. For example, the distance from the camera to the object, the coordinate values for an axis which is not parallel to the image plane, or the amount of disparity with respect to another camera (e.g., camera A) may be employed.

Although the depth map here is provided as an image, it may be provided in any manner if similar information can be obtained.

The motion information generation unit 205 generates motion information for the decoding target image by using the reference viewpoint motion information and the depth map.

The image decoding unit 206 decodes the decoding target image from the bit stream by using the generated motion information.

The reference image memory 207 stores the obtained decoding target image for future decoding.

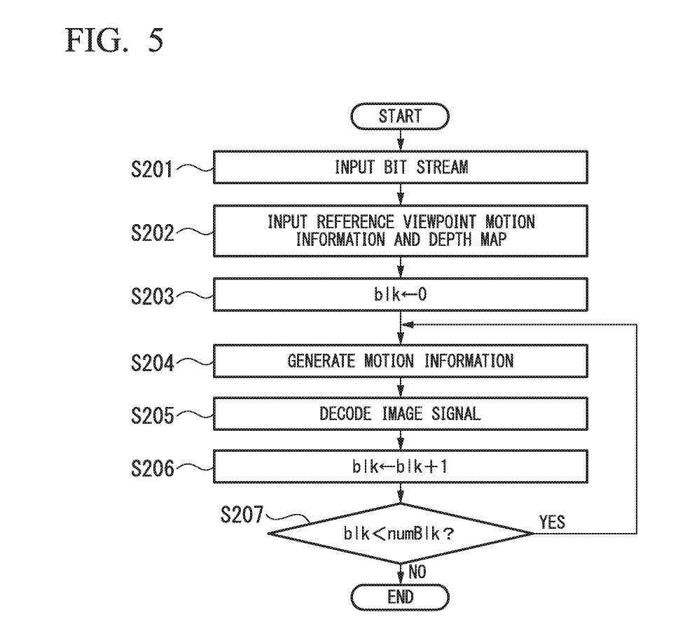

Next, with reference to FIG. 5, the operation of the video decoding apparatus 200 of FIG. 4 will be explained. FIG. 5 is a flowchart that shows the operation of the video decoding apparatus 200 of FIG. 4.

First, the bit stream input unit 201 inputs a bit stream obtained by encoding the decoding target image into the video decoding apparatus 200 and stores it in the bit stream memory 202 (see step S201).

Next, the reference viewpoint motion information input unit 203 inputs reference viewpoint motion information into the video decoding apparatus 200 while the depth map input unit 204 makes the depth map into the video decoding apparatus 200. These input items are each output to the motion information generation unit 205 (see step S202).

Here, it is assumed that the reference viewpoint motion information and the depth map input in step S202 are identical to those used in a corresponding encoding apparatus. This is because generation of encoding noise (e.g., drift) can be suppressed by using the completely same information as information which can be obtained in the encoding apparatus. However, if generation of such encoding noise is acceptable, information which differs from that used in the encoding apparatus may be input.

As for the depth map, instead of a depth map which has been decoded separately, a depth map estimated by applying stereo matching or the like to a multi-viewpoint video which is decoded for a plurality of cameras, or a depth map estimated by using a decoded disparity or motion vector may be utilized.

The reference viewpoint motion information may be motion information used when a video from the reference viewpoint was decoded or motion information which has been encoded separately for the reference viewpoint. In addition, motion information obtained by decoding a video from the reference viewpoint and performing estimation according to the decoded video may be utilized.

After the input of the bit stream, the reference viewpoint motion information, and the depth map is completed, the decoding target image is divided into regions having a predetermined size, and the video signal of the decoding target image is decoded from the bit stream for each divided region (see steps S204 to S205).

More specifically, given “blk” for a decoding target region index and “numBlks” for the total number of decoding target regions, blk is initialized to be 0 (see step S203), and then the following process (from step S204 to step S205) is repeated adding 1 to blk each time (see step S206) until blk reaches numBlks (see step S207).

In ordinary decoding, the decoding target image is divided into processing target blocks called “macroblocks” each being formed as 16×16 pixels. However, it may be divided into blocks having another block size if the condition is the same as that in the encoding apparatus. In addition, instead of dividing the entire image into regions having the same size, the divided regions may have individual sizes.

In the process repeated for each decoding target region, first, the motion information generation unit 205 generates motion information for the decoding target region blk (see step S204). This process is identical to the above-described process in step S104 except for difference between the decoding target region and the encoding target region.

Next, after the motion information for the decoding target region blk is obtained, the image decoding unit 206 decodes the video signal (specifically, pixel values) in the decoding target region blk from the bit stream while performing the motion-compensated prediction by using the motion information and an image stored in the reference image memory 207 (see step S205). The obtained decoding target image is stored in the reference image memory 207 and functions as a signal output from the decoding apparatus 200.

In order to decode the video signal, a method corresponding to the method used in the encoding is employed.

For example, if generally known encoding such as MPEG-2 or H.264/AVC was used, the video signal is decoded by sequentially applying entropy decoding, inverse binarization, inverse quantization, and frequency inverse transformation such as IDCT to the bit stream so as to obtain a two-dimensional signal; adding a predicted image to the two-dimensional signal; and finally performing clipping within the range of relevant pixel values.

In the above explanation, the motion information generation is performed for each divided region of the encoding target image or the decoding target image. However, motion information may be generated and stored in advance for each of all divided regions, and the motion information stored for each region may be referred to.

In addition, although the above explanation employs an operation of encoding or decoding the entire image, the operation may be applied to part of the image.

In this case, whether the operation is to be applied or not may be determined and a flag that indicates a result of the determination may be encoded or decoded, or the result may be designated by using an arbitrary device.

For example, whether the operation is to be applied or not may be represented as one of the modes that indicate methods of generating a predicted image for each region.

Additionally, in the above explanation, the transformation matrix is always generated. However, the transformation matrix does not change as long as the positional relationship between the encoding or decoding target viewpoint and the reference viewpoint or the definition of the depth (i.e., a three-dimensional plane corresponding to the depth) does not change. Therefore, a set of the transformation matrices may be computed in advance. In this case, it is unnecessary to recompute the transformation matrix for each frame or region.

That is, every time the encoding or decoding target image is changed, a positional relationship between the encoding or decoding target viewpoint and the reference viewpoint, which is represented by using a separately provided camera parameter, is compared with a positional relationship between the encoding or decoding target viewpoint and the reference viewpoint, which is represented by using a camera parameter for the immediately preceding frame. When no or small variation is present in the positional relationship, a set of the transformation matrices used in the immediately preceding frame is directly used, otherwise the computation of the set of the transformation matrices is performed.

In the computation of the set of the transformation matrices, instead of recomputing all transformation matrices, the transformation matrices corresponding to (i) a reference viewpoint which has a positional relationship different from that of the immediately preceding frame and (ii) a depth having a changed definition may be identified, and the relevant recomputation may be applied to only the identified items.

Additionally, whether the transformation matrix recomputation is necessary or not may be checked only in the encoding apparatus, and the result thereof may be encoded and transmitted to the decoding apparatus, which may determine whether the transformation matrices are to be recomputed or not based on the transmitted information.

For the information which indicates whether or not the recomputation is necessary, only one information item may be assigned to the entire frame, or the information may be applied to each reference viewpoint or depth.

Furthermore, in the above explanation, the transformation matrix is generated for each depth value of the representative depth. However, one depth value may be determined as a quantization depth for each region (determined separately) for the depth value, and the transformation matrix may be determined for the quantization depth value. Since the representative depth can have any depth value within the depth value range, the transformation matrices for all depth values may be required. However, when employing the above method, the depth value which requires the transformation matrix can be limited to only the depth value identical to the quantization depth. When the transformation matrix is computed after computing the representative depth, the quantization depth is obtained from the depth value range that includes the representative depth, and the transformation matrix is computed by using the quantization depth. In particular, when one quantization depth is applied to the entire depth value range, the only one transformation matrix is determined for the reference viewpoint.

The range for the depth value utilized to determine the quantization depth and the depth value of the quantization depth in each range may be determined by any method. For example, they may be determined according to a depth distribution in a depth map. In this case, the motion in a video corresponding to the depth map may be examined, and only the depth for a region where a motion equal to or more than a specific value exists may be determined to be a target for the examination of the depth value distribution. In such a case, when a large motion is present, the motion information can be shared with different viewpoints and thus it is possible to reduce a larger amount of code.

In addition, when the quantization depth is determined by a method that cannot be employed in the decoding apparatus, the encoding apparatus may encode and transmit a determined quantization method (utilized to determine the range for the depth value corresponding to each quantization depth, and the depth value of the quantization depth), and the decoding apparatus may decode and obtain the quantization method from the encoded bit stream. If one quantization depth is applied to the entire target, not the quantization method but the value of the quantization depth may be encoded or decoded.

In the above explanation, the transformation matrix is also generated in the decoding apparatus which uses a camera parameter or the like. However, the encoding apparatus may encode and transmit the transformation matrix obtained by the computation. In this case, the decoding apparatus does not generate the transformation matrix from a camera parameter or the like and obtains the transformation matrix by means of the decoding from the relevant bit stream.

Additionally, in the above explanation, the transformation matrix is always used. However, the camera parameter may be checked, where (i) if a parallel correspondence relationship is provided between relevant viewpoints, a look-up table (utilized for conversion between the input and output) is generated and conversion between the depth and the disparity vector is performed according to the look-up table, and (ii) if no parallel correspondence relationship is provided between relevant viewpoints, the method according to the present invention may be employed.

In addition, the above check is performed only in the encoding apparatus, and information which indicates the employed method (between the above two methods) may be encoded. In such a case, the decoding apparatus decodes the information so as to determine which of the two methods is to be used.

In the above explanation, the homography matrix is used as the transformation matrix. However, another matrix may be used, which can transform the pixel position on the encoding or decoding target image to a corresponding pixel position from the reference viewpoint. For example, a simplified matrix may be utilized instead of a strict homography matrix. In addition, an affine transformation matrix, a projection matrix, or a matrix generated by combining a plurality of transformation matrices may be utilized.

By using such a different matrix, it is possible to appropriately control the accuracy or computation amount of the transformation, the updating frequency of the transformation matrix, the amount of code required to transmit the transformation matrix, or the like. Here, in order to prevent the generation of the encoding noise, an identical transformation matrix should be used between the encoding and the decoding.

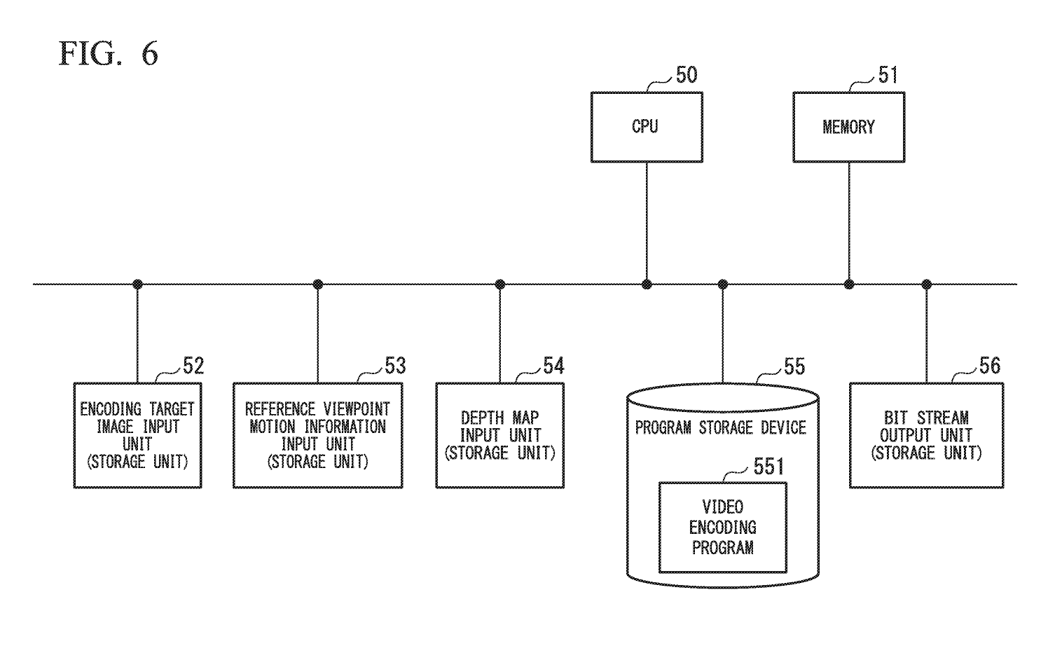

FIG. 6 is a block diagram that shows an example of a hardware configuration of the video encoding apparatus 100 (shown in FIG. 1) formed using a computer and a software program.

In the system of FIG. 6, the following elements are connected via a bus:

(i) a CPU 50 that executes the relevant program;
(ii) a memory 51 (e.g., RAM) that stores the program and data accessed by the CPU 50:
(iii) an encoding target image input unit 52 that makes a video signal of an encoding target from a camera or the like input into the video encoding apparatus and may be a storage unit (e.g., disk device) which stores the video signal:
(iv) a reference viewpoint motion information input unit 53 that inputs motion information for a reference viewpoint (from a memory or the like) into the video encoding apparatus and may be a storage unit (e.g., disk device) which stores the motion information;
(v) a depth map input unit 54 that inputs a depth map for a viewpoint (e.g., depth camera utilized to obtain depth information) from which the encoding target image is photographed:
(vi) a program storage device 55 that stores a video encoding program 551 which is a software program for making the CPU 50 execute the video encoding operation; and
(vii) a bit stream output unit 56 that outputs a bit stream, which is generated by the CPU 50 which executes the video encoding program 551 loaded on the memory 51, via a network or the like, where the output unit 56 may be a storage unit (e.g., disk device) which stores the motion information.

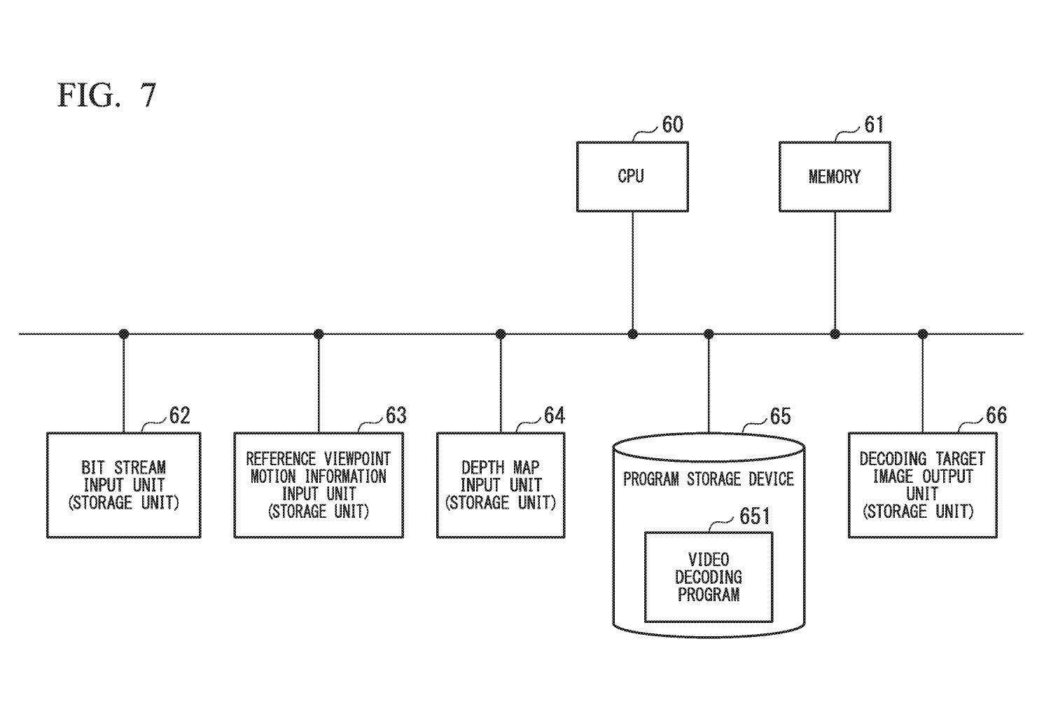

FIG. 7 is a block diagram that shows an example of a hardware configuration of the video decoding apparatus 200 (shown in FIG. 4) formed using a computer and a software program.

In the system of FIG. 7, the following elements are connected via a bus:

(i) a CPU 60 that executes the relevant program;
(ii) a memory 61 (e.g., RAM) that stores the program and data accessed by the CPU 60:
(iii) a bit stream input unit 62 that makes a bit stream encoded by the encoding apparatus according to the present method into the video decoding apparatus and may be a storage unit (e.g., disk device) which stores the bit stream:
(iv) a reference viewpoint motion information input unit 63 that inputs motion information for a reference viewpoint (from a memory or the like) into the video decoding apparatus and may be a storage unit (e.g., disk device) which stores the motion information;
(v) a depth map input unit 64 that inputs a depth map for a viewpoint (e.g., depth camera) from which the decoding target is photographed;
(vi) a program storage device 65 that stores a video decoding program 651 which is a software program for making the CPU 60 execute the video decoding operation; and
(vii) a decoding target image output unit 66 that outputs a decoding target image, which is obtained by the CPU 60 which executes the video decoding program 651 loaded on the memory 61 so as to decode the bit stream, to a reproduction apparatus or the like, where the output unit 66 may be a storage unit (e.g., disk device) which stores the motion information.

The video encoding apparatus 100 and the video decoding apparatus 200 in each embodiment described above may be implemented by utilizing a computer. In this case, a program for executing the relevant functions may be stored in a computer-readable storage medium, and the program stored in the storage medium may be loaded and executed on a computer system, so as to implement the relevant apparatus.

Here, the computer system has hardware resources which may include an OS and peripheral devices.

The above computer-readable storage medium is a storage device, for example, a portable medium such as a flexible disk, a magneto optical disk, a ROM, or a CD-ROM, or a memory device such as a hard disk built in a computer system.

The computer-readable storage medium may also include a device for temporarily storing the program, for example, (i) a device for dynamically storing the program for a short time, such as a communication line used when transmitting the program via a network (e.g., the Internet) or a communication line (e.g., a telephone line), or (ii) a volatile memory in a computer system which functions as a server or client in such a transmission.

In addition, the program may execute a part of the above-explained functions. The program may also be a “differential” program so that the above-described functions can be executed by a combination of the differential program and an existing program which has already been stored in the relevant computer system. Furthermore, the program may be implemented by utilizing a hardware devise such as a PLD (programmable logic device) or an FPGA (field programmable gate array).

While the embodiments of the present invention have been described and shown above, it should be understood that these are exemplary embodiments of the invention and are not to be considered as limiting. Additions, omissions, substitutions, and other modifications can be made without departing from the technical concept and scope of the present invention.

### INDUSTRIAL APPLICABILITY

The present invention can be applied to a purpose which essentially requires the following: in the encoding or decoding of free viewpoint video data formed by videos from a plurality of viewpoints and depth maps corresponding to the videos, even if the directions of the viewpoints are not parallel to each other, highly accurate motion information prediction between the viewpoints is implemented while a reduced amount of computation is maintained, which can implement a high degree of encoding efficiency.

### REFERENCE SYMBOLS

100 video encoding apparatus
101 encoding target image input unit
102 encoding target image memory
103 reference viewpoint motion information input unit
104 depth map input unit
105 motion information generation unit
106 image encoding unit
107 image decoding unit
108 reference image memory
200 video decoding apparatus
201 bit stream input unit
202 bit stream memory
203 reference viewpoint motion information input unit
204 depth map input unit
205 motion information generation unit
206 image decoding unit
207 reference image memory

1. A video encoding apparatus utilized when an encoding target image, which is one frame of a multi-viewpoint video consisting of videos from a plurality of different viewpoints, is encoded, wherein the encoding is executed while performing prediction between different viewpoints for each of encoding target regions divided from the encoding target image, and the apparatus comprises:
a representative depth determination device that determines a representative depth from a depth map corresponding to an object in the multi-viewpoint video;
a transformation matrix determination device that determines based on the representative depth, a transformation matrix that transforms a position on the encoding target image into a position on a reference viewpoint image from a reference viewpoint which differs from a viewpoint of the encoding target image;
a representative position determination device that determines a representative position which belongs to the relevant encoding target region;
a corresponding position determination device that determines a corresponding position which corresponds to the representative position and belongs to the reference viewpoint image by using the representative position and the transformation matrix;
a motion information generation device that generates, based on the corresponding position, synthesized motion information assigned to the encoding target region, according to reference viewpoint motion information as motion information for the reference viewpoint image;
a predicted image generation device that generates a predicted image for the encoding target region by using the synthesized motion information;
a depth region determination device that determines a depth region on the depth map, where the depth region corresponds to the encoding target region; and
a depth reference disparity vector determination device that determines, for the encoding target region, a depth reference disparity vector that is a disparity vector for the depth map,
wherein the representative depth determination device determines the representative depth from a depth map that corresponds to the depth region; and
the depth region determination device determines a region indicated by the depth reference disparity vector to be the depth region.

2. (canceled)

3. (canceled)

4. The video encoding apparatus in accordance with claim 1, wherein:
the depth reference disparity vector determination device determines the depth reference disparity vector by using a disparity vector used when a region adjacent to the encoding target region was encoded.

5. (canceled)

6. A video encoding apparatus utilized when an encoding target image, which is one frame of a multi-viewpoint video consisting of videos from a plurality of different viewpoints, is encoded, wherein the encoding is executed while performing prediction between different viewpoints for each of encoding target regions divided from the encoding target image, and the apparatus comprises:
a representative depth determination device that determines a representative depth from a depth map corresponding to an object in the multi-viewpoint video;
a transformation matrix determination device that determines based on the representative depth, a transformation matrix that transforms a position on the encoding target image into a position on a reference viewpoint image from a reference viewpoint which differs from a viewpoint of the encoding target image;
a representative position determination device that determines a representative position which belongs to the relevant encoding target region;
a corresponding position determination device that determines a corresponding position which corresponds to the representative position and belongs to the reference viewpoint image by using the representative position and the transformation matrix;
a motion information generation device that generates, based on the corresponding position, synthesized motion information assigned to the encoding target region, according to reference viewpoint motion information as motion information for the reference viewpoint image;
a predicted image generation device that generates a predicted image for the encoding target region by using the synthesized motion information; and
a synthesized motion information transformation device that performs transformation of the synthesized motion information by using the transformation matrix,
wherein the predicted image generation device uses the transformed synthesized motion information.

7. A video encoding apparatus utilized when an encoding target image, which is one frame of a multi-viewpoint video consisting of videos from a plurality of different viewpoints, is encoded, wherein the encoding is executed while performing prediction between different viewpoints for each of encoding target regions divided from the encoding target image, and the apparatus comprises:
a representative depth determination device that determines a representative depth from a depth map corresponding to an object in the multi-viewpoint video;
a transformation matrix determination device that determines based on the representative depth, a transformation matrix that transforms a position on the encoding target image into a position on a reference viewpoint image from a reference viewpoint which differs from a viewpoint of the encoding target image;
a representative position determination device that determines a representative position which belongs to the relevant encoding target region;
a corresponding position determination device that determines a corresponding position which corresponds to the representative position and belongs to the reference viewpoint image by using the representative position and the transformation matrix;
a motion information generation device that generates, based on the corresponding position, synthesized motion information assigned to the encoding target region, according to reference viewpoint motion information as motion information for the reference viewpoint image;
a predicted image generation device that generates a predicted image for the encoding target region by using the synthesized motion information;
a past depth determination device that determines, based on the corresponding position and the synthesized motion information, a past depth from the depth map;
an inverse transformation matrix determination device that determines based on the past depth, an inverse transformation matrix that transforms the position on the reference viewpoint image into the position on the encoding target image; and
a synthesized motion information transformation device that performs transformation of the synthesized motion information by using the inverse transformation matrix,
wherein the predicted image generation device uses the transformed synthesized motion information.

8.-18. (canceled)

19. A video encoding apparatus utilized when an encoding target image, which is one frame of a multi-viewpoint video consisting of videos from a plurality of different viewpoints, is encoded, wherein the encoding is executed while performing prediction between different viewpoints for each of encoding target regions divided from the encoding target image, and the apparatus comprises:
a representative depth determination device that determines a representative depth from a depth map corresponding to an object in the multi-viewpoint video;
a transformation matrix determination device that determines based on the representative depth, a transformation matrix that transforms a position on the encoding target image into a position on a reference viewpoint image from a reference viewpoint which differs from a viewpoint of the encoding target image;
a representative position determination device that determines a representative position which belongs to the relevant encoding target region;
a corresponding position determination device that determines a corresponding position which corresponds to the representative position and belongs to the reference viewpoint image by using the representative position and the transformation matrix;
a motion information generation device that generates, based on the corresponding position, synthesized motion information assigned to the encoding target region, according to reference viewpoint motion information as motion information for the reference viewpoint image; and
a predicted image generation device that generates a predicted image for the encoding target region by using the synthesized motion information,
wherein a positional relationship between the viewpoint of the encoding target image and the reference viewpoint has no variation or a variation smaller than or equal to a predetermined value, the transformation matrix determination by the transformation matrix determination device is not performed, and the corresponding position determination device uses the transformation matrix used for an image which was encoded immediately before.

20. A video decoding apparatus utilized when a decoding target image is decoded from encoded data of a multi-viewpoint video consisting of videos from a plurality of different viewpoints, wherein the decoding is executed while performing prediction between different viewpoints for each of decoding target regions divided from the decoding target image, and the apparatus comprises:
a representative depth determination device that determines a representative depth from a depth map corresponding to an object in the multi-viewpoint video;
a transformation matrix determination device that determines based on the representative depth, a transformation matrix that transforms a position on the decoding target image into a position on a reference viewpoint image from a reference viewpoint which differs from a viewpoint of the decoding target image;
a representative position determination device that determines a representative position which belongs to the relevant decoding target region;
a corresponding position determination device that determines a corresponding position which corresponds to the representative position and belongs to the reference viewpoint image by using the representative position and the transformation matrix;
a motion information generation device that generates, based on the corresponding position, synthesized motion information assigned to the decoding target region, according to reference viewpoint motion information as motion information for the reference viewpoint image;
a predicted image generation device that generates a predicted image for the decoding target region by using the synthesized motion information;
a depth region determination device that determines a depth region on the depth map, where the depth region corresponds to the decoding target region, and
a depth reference disparity vector determination device that determines, for the decoding target region, a depth reference disparity vector that is a disparity vector for the depth map,
wherein the representative depth determination device determines the representative depth from a depth map that corresponds to the depth region; and
the depth region determination device determines a region indicated by the depth reference disparity vector to be the depth region.

21. The video decoding apparatus in accordance with claim 20, wherein:
the depth reference disparity vector determination device determines the depth reference disparity vector by using a disparity vector used when a region adjacent to the decoding target region was encoded.

22. A video decoding apparatus utilized when a decoding target image is decoded from encoded data of a multi-viewpoint video consisting of videos from a plurality of different viewpoints, wherein the decoding is executed while performing prediction between different viewpoints for each of decoding target regions divided from the decoding target image, and the apparatus comprises:
a representative depth determination device that determines a representative depth from a depth map corresponding to an object in the multi-viewpoint video;
a transformation matrix determination device that determines based on the representative depth, a transformation matrix that transforms a position on the decoding target image into a position on a reference viewpoint image from a reference viewpoint which differs from a viewpoint of the decoding target image;
a representative position determination device that determines a representative position which belongs to the relevant decoding target region;
a corresponding position determination device that determines a corresponding position which corresponds to the representative position and belongs to the reference viewpoint image by using the representative position and the transformation matrix;
a motion information generation device that generates, based on the corresponding position, synthesized motion information assigned to the decoding target region, according to reference viewpoint motion information as motion information for the reference viewpoint image;
a predicted image generation device that generates a predicted image for the decoding target region by using the synthesized motion information; and
a synthesized motion information transformation device that performs transformation of the synthesized motion information by using the transformation matrix,
wherein the predicted image generation device uses the transformed synthesized motion information.

23. A video decoding apparatus utilized when a decoding target image is decoded from encoded data of a multi-viewpoint video consisting of videos from a plurality of different viewpoints, wherein the decoding is executed while performing prediction between different viewpoints for each of decoding target regions divided from the decoding target image, and the apparatus comprises:
a representative depth determination device that determines a representative depth from a depth map corresponding to an object in the multi-viewpoint video;
a transformation matrix determination device that determines based on the representative depth, a transformation matrix that transforms a position on the decoding target image into a position on a reference viewpoint image from a reference viewpoint which differs from a viewpoint of the decoding target image;
a representative position determination device that determines a representative position which belongs to the relevant decoding target region;
a corresponding position determination device that determines a corresponding position which corresponds to the representative position and belongs to the reference viewpoint image by using the representative position and the transformation matrix;
a motion information generation device that generates, based on the corresponding position, synthesized motion information assigned to the decoding target region, according to reference viewpoint motion information as motion information for the reference viewpoint image;
a predicted image generation device that generates a predicted image for the decoding target region by using the synthesized motion information;
a past depth determination device that determines, based on the corresponding position and the synthesized motion information, a past depth from the depth map;
an inverse transformation matrix determination device that determines based on the past depth, an inverse transformation matrix that transforms the position on the reference viewpoint image into the position on the decoding target image; and
a synthesized motion information transformation device that performs transformation of the synthesized motion information by using the inverse transformation matrix,
wherein the predicted image generation device uses the transformed synthesized motion information.

24. A video decoding apparatus utilized when a decoding target image is decoded from encoded data of a multi-viewpoint video consisting of videos from a plurality of different viewpoints, wherein the decoding is executed while performing prediction between different viewpoints for each of decoding target regions divided from the decoding target image, and the apparatus comprises:
a representative depth determination device that determines a representative depth from a depth map corresponding to an object in the multi-viewpoint video;
a transformation matrix determination device that determines based on the representative depth, a transformation matrix that transforms a position on the decoding target image into a position on a reference viewpoint image from a reference viewpoint which differs from a viewpoint of the decoding target image;
a representative position determination device that determines a representative position which belongs to the relevant decoding target region;
a corresponding position determination device that determines a corresponding position which corresponds to the representative position and belongs to the reference viewpoint image by using the representative position and the transformation matrix;
a motion information generation device that generates, based on the corresponding position, synthesized motion information assigned to the decoding target region, according to reference viewpoint motion information as motion information for the reference viewpoint image; and
a predicted image generation device that generates a predicted image for the decoding target region by using the synthesized motion information,
wherein a positional relationship between the viewpoint of the decoding target image and the reference viewpoint has no variation or a variation smaller than or equal to a predetermined value, the transformation matrix determination by the transformation matrix determination device is not performed, and the corresponding position determination device uses the transformation matrix used for an image which was decoded immediately before.

25. A video decoding method utilized when a decoding target image is decoded from encoded data of a multi-viewpoint video consisting of videos from a plurality of different viewpoints, wherein the decoding is executed while performing prediction between different viewpoints for each of decoding target regions divided from the decoding target image, and the method comprises:
a representative depth determination step that determines a representative depth from a depth map corresponding to an object in the multi-viewpoint video;
a transformation matrix determination step that determines based on the representative depth, a transformation matrix that transforms a position on the decoding target image into a position on a reference viewpoint image from a reference viewpoint which differs from a viewpoint of the decoding target image;
a representative position determination step that determines a representative position which belongs to the relevant decoding target region;
a corresponding position determination step that determines a corresponding position which corresponds to the representative position and belongs to the reference viewpoint image by using the representative position and the transformation matrix;
a motion information generation step that generates, based on the corresponding position, synthesized motion information assigned to the decoding target region, according to reference viewpoint motion information as motion information for the reference viewpoint image;
a predicted image generation step that generates a predicted image for the decoding target region by using the synthesized motion information;
a depth region determination step that determines a depth region on the depth map, where the depth region corresponds to the decoding target region, and
a depth reference disparity vector determination step that determines, for the decoding target region, a depth reference disparity vector that is a disparity vector for the depth map,
wherein the representative depth determination step determines the representative depth from a depth map that corresponds to the depth region; and
the depth region determination step determines a region indicated by the depth reference disparity vector to be the depth region.

26. The video decoding method in accordance with claim 20, wherein:
the depth reference disparity vector determination step determines the depth reference disparity vector by using a disparity vector used when a region adjacent to the decoding target region was encoded.

27. A video decoding method utilized when a decoding target image is decoded from encoded data of a multi-viewpoint video consisting of videos from a plurality of different viewpoints, wherein the decoding is executed while performing prediction between different viewpoints for each of decoding target regions divided from the decoding target image, and the method comprises:
a representative depth determination step that determines a representative depth from a depth map corresponding to an object in the multi-viewpoint video;
a transformation matrix determination step that determines based on the representative depth, a transformation matrix that transforms a position on the decoding target image into a position on a reference viewpoint image from a reference viewpoint which differs from a viewpoint of the decoding target image;
a representative position determination step that determines a representative position which belongs to the relevant decoding target region;
a corresponding position determination step that determines a corresponding position which corresponds to the representative position and belongs to the reference viewpoint image by using the representative position and the transformation matrix;
a motion information generation step that generates, based on the corresponding position, synthesized motion information assigned to the decoding target region, according to reference viewpoint motion information as motion information for the reference viewpoint image;
a predicted image generation step that generates a predicted image for the decoding target region by using the synthesized motion information; and
a synthesized motion information transformation step that performs transformation of the synthesized motion information by using the transformation matrix,
wherein the predicted image generation step uses the transformed synthesized motion information.

28. A video decoding method utilized when a decoding target image is decoded from encoded data of a multi-viewpoint video consisting of videos from a plurality of different viewpoints, wherein the decoding is executed while performing prediction between different viewpoints for each of decoding target regions divided from the decoding target image, and the method comprises:
a representative depth determination step that determines a representative depth from a depth map corresponding to an object in the multi-viewpoint video;
a transformation matrix determination step that determines based on the representative depth, a transformation matrix that transforms a position on the decoding target image into a position on a reference viewpoint image from a reference viewpoint which differs from a viewpoint of the decoding target image;
a representative position determination step that determines a representative position which belongs to the relevant decoding target region;
a corresponding position determination step that determines a corresponding position which corresponds to the representative position and belongs to the reference viewpoint image by using the representative position and the transformation matrix;
a motion information generation step that generates, based on the corresponding position, synthesized motion information assigned to the decoding target region, according to reference viewpoint motion information as motion information for the reference viewpoint image;
a predicted image generation step that generates a predicted image for the decoding target region by using the synthesized motion information;
a past depth determination step that determines, based on the corresponding position and the synthesized motion information, a past depth from the depth map;
an inverse transformation matrix determination step that determines based on the past depth, an inverse transformation matrix that transforms the position on the reference viewpoint image into the position on the decoding target image; and
a synthesized motion information transformation step that performs transformation of the synthesized motion information by using the inverse transformation matrix,
wherein the predicted image generation step uses the transformed synthesized motion information.

29. A video decoding method utilized when a decoding target image is decoded from encoded data of a multi-viewpoint video consisting of videos from a plurality of different viewpoints, wherein the decoding is executed while performing prediction between different viewpoints for each of decoding target regions divided from the decoding target image, and the method comprises:
a representative depth determination step that determines a representative depth from a depth map corresponding to an object in the multi-viewpoint video;
a transformation matrix determination step that determines based on the representative depth, a transformation matrix that transforms a position on the decoding target image into a position on a reference viewpoint image from a reference viewpoint which differs from a viewpoint of the decoding target image;
a representative position determination step that determines a representative position which belongs to the relevant decoding target region;
a corresponding position determination step that determines a corresponding position which corresponds to the representative position and belongs to the reference viewpoint image by using the representative position and the transformation matrix;
a motion information generation step that generates, based on the corresponding position, synthesized motion information assigned to the decoding target region, according to reference viewpoint motion information as motion information for the reference viewpoint image; and
a predicted image generation step that generates a predicted image for the decoding target region by using the synthesized motion information,
wherein a positional relationship between the viewpoint of the decoding target image and the reference viewpoint has no variation or a variation smaller than or equal to a predetermined value, the transformation matrix determination by the transformation matrix determination step is not performed, and the corresponding position determination step uses the transformation matrix used for an image which was decoded immediately before.

30. A video encoding method utilized when an encoding target image, which is one frame of a multi-viewpoint video consisting of videos from a plurality of different viewpoints, is encoded, wherein the encoding is executed while performing prediction between different viewpoints for each of encoding target regions divided from the encoding target image, and the method comprises:
a representative depth determination step that determines a representative depth from a depth map corresponding to an object in the multi-viewpoint video;
a transformation matrix determination step that determines based on the representative depth, a transformation matrix that transforms a position on the encoding target image into a position on a reference viewpoint image from a reference viewpoint which differs from a viewpoint of the encoding target image;
a representative position determination step that determines a representative position which belongs to the relevant encoding target region;
a corresponding position determination step that determines a corresponding position which corresponds to the representative position and belongs to the reference viewpoint image by using the representative position and the transformation matrix;
a motion information generation step that generates, based on the corresponding position, synthesized motion information assigned to the encoding target region, according to reference viewpoint motion information as motion information for the reference viewpoint image;
a predicted image generation step that generates a predicted image for the encoding target region by using the synthesized motion information;
a depth region determination step that determines a depth region on the depth map, where the depth region corresponds to the encoding target region; and
a depth reference disparity vector determination step that determines, for the encoding target region, a depth reference disparity vector that is a disparity vector for the depth map,
wherein the representative depth determination step determines the representative depth from a depth map that corresponds to the depth region; and
the depth region determination step determines a region indicated by the depth reference disparity vector to be the depth region.

31. A video decoding program that makes a computer execute the video decoding method in accordance with claim 25.

32. A video encoding program that makes a computer execute the video encoding method in accordance with claim 30.
